(19) United States
(12) Patent Application Publication
(10) Pub. No.: US 2012/0311660 A1
(43) Pub. Date: Dec. 6, 2012

(54) SYSTEM AND METHOD FOR MANAGING IPv6 ADDRESS AND ACCESS POLICY

(75) Inventors: Seon Ok Park, Gwacheon-si (KR); Se-Jun An, Gwacheon-si (KR); Seunghoon Jeong, Daegu (KR)

(73) Assignee: SAMSUNG SDS CO., LTD., Seoul (KR)

(21) Appl. No.: 13/512,184

(22) PCT Filed: Nov. 22, 2010
(86) PCT No.: PCT/KR2010/008228

§ 371 Date: May 25, 2012

(30) Foreign Application Priority Data
Nov. 26, 2009 (KR) 10-2009-0115013

(51) Int. Cl. G06F 21/00

(52) U.S. Cl. 726/1

(57) ABSTRACT

A policy server receives an access policy information request message, and authenticates the request. When the authentication is successful, an access policy storage is accessed to obtain access policy information corresponding to the source of the message. The server outputs the corresponding access policy information. The information includes an IPv6 address for use, at the source, as a new source address. The information may also include a terminal address setting function, a rebooting option adding function upon terminal address setting, a default gateway setting function, a domain name service (DNS) server address setting function, a tunnel function on or off function, a neighbor cache clearing function, and/or a privacy extension on or off function.

### CROSS REFERENCE TO RELATED APPLICATIONS

This application is a National Stage Entry of PCT/KR2010/008228 filed on Nov. 22, 2010, which claims priority from Korean Patent Application KR 10-2009-0115013 filed on Nov. 26, 2009, the disclosures of both of which are incorporated in their entirety, herein, by reference.

### FIELD

Apparatuses, systems, and methods consistent with the exemplary embodiments include a system, a server, and a method for managing an Internet protocol version 6 (IPv6) address and access policy, and more particularly, to a system, a server, and a method for a network administrator to remotely manage an IPv6 address and a network access policy to be assigned to a user using communication between a policy server and a terminal.

### DESCRIPTION OF THE RELATED ART

Related Internet Protocol (IP) systems are based on Internet protocol version 4 (IPv4) technology having a 32-bit address system. However, with the increase in the use of the Internet and the development of increasingly ubiquitous technology, 32-bit addresses are rapidly being exhausted. To solve this problem, the Internet Engineering Task Force (IETF) has standardized IPv6 on an approach that utilizes a 128-bit address system.

However, because an IPv6 address is 128 bits long, it is very long and complex compared to an IPv4 address. For this reason, it is very rare for a terminal (e.g., personal computer (PC)) user to manually set the IPv6 address of the terminal. In addition, the method, of automatically assigning an address using a dynamic host configuration protocol for IPv6 (DHCPv6), router advertisement (RA), etc., has been generalized. In other words, dynamic automatic address assignment schemes, such as DHCPv6 and RA, are currently used for IPv6 addresses in most network environments, and are automatically set through communication between protocols.

The foregoing related art method may be convenient for assigning all IPv6 addresses together. On the other hand, under such an approach, it is almost impossible to perform access policy management, e.g., assigning a static address for a user, or setting an access limitation. Therefore, individual-specific control is likewise almost impossible to achieve. In certain situations, however, it is necessary for a user to manually set and control a terminal. In particular, a network in which an emphasis is put on security, such as an intranet of a corporation, may require firewall rules to be set, as well as limitations on the access of a specific user, and so on. In this case, IPv6 addresses need to be fixed according on a user basis.

Furthermore, using the existing, related-art dynamic automatic assignment scheme that sets up everything based on automatic communication between equipment, individual IPv6 addresses cannot be controlled. Furthermore, individual security rules cannot be applied to firewalls in Windows-based PCs because of changes in source IP addresses caused by operations in line with request for comments (RFC) 4941. Also, in a Windows-based PC, an automatic tunneling function such as 6 to 4 is set as a default for an individual to use IPv6. Thus, it is difficult for a security manager to be certain that IPv6 communication between users is being performed only through encapsulated packets, and a serious problem may thus occur in the security management of a corporation.

Further, when an individual terminal needs to use a static IPv6 address, a user needs to manually set the address and also turn off a temporary address use function based on RFC 4941, resulting in considerable inconvenience. Moreover, a network administrator cannot assign or manage an IPv6 address based on an internal policy either, and even if a user manually sets an IPv6 address, the network administrator would thus need to check the address, in person, in order to properly verify that the IPv6 address is correctly set because in the related art, it is impossible to verify this fact remotely.

### SUMMARY

One or more exemplary embodiments may overcome the above disadvantages and other disadvantages not described above. However, it is understood that one or more exemplary embodiment are not required to overcome the disadvantages described above, and may not overcome any of the problems described above.

One or more aspects of the exemplary embodiments provide a system, server, and method for a network administrator to remotely manage an Internet protocol version 6 (IPv6) address and a network access policy to be assigned to a user using communication between a policy server and a terminal.

One or more aspects of the exemplary embodiments also provide a system, server, and method in which an agent capable of communicating with a policy server is installed in an IPv6 terminal and enables access policy information on IPv6 address assignment, access-permitted workplaces, use of a private extension function, etc. to be downloaded from the policy server and the IPv6 terminal to be set, such that a network administrator can remotely manage an IPv6 address and an access policy.

One or more aspects of the exemplary embodiments also provide a system, server, and method capable of readily performing network administration such as security by including information, such as a previously assigned IPv4 address, the subnet address of a workplace, a detailed access policy and a security level, in an IPv6 address of a terminal when the IPv6 address is set.

According to an aspect of an exemplary embodiment, there is provided a system for managing an Internet protocol version 6 (IPv6) address and an access policy, including: a policy server configured to manage network access policy information set on a per-user or user group basis; and a user terminal having an agent module configured to access the policy server, authenticate a user, receive access policy information corresponding to the user, and automatically set an IPv6 address and an access policy function of the terminal on the basis of the access policy information.

According to an aspect of another exemplary embodiment, there is provided a policy server for managing an IPv6 address and an access policy, including: an access policy setter configured to set IPv6 addresses and network access policies to be assigned on a per-user or user group basis and generate user-specific access policy information; a user authenticator configured to, when a user terminal accesses, request user information from the user terminal and authenticate a user; and an access policy storage configured to store the user-specific access policy information generated by the access policy setter.

According to an aspect of another exemplary embodiment, there is provided a method of managing an IPv6 address and an access policy, including: a) setting, at a policy server, IPv6 addresses and network access policies on a per-user or user group basis, and generating user-specific access policy information; b) accessing, at a user terminal, the policy server, authenticating a user, and receiving access policy information corresponding to the user; and c) setting, at the user terminal, an IPv6 address and an access policy function of the terminal on the basis of the access policy information.

According to another exemplary embodiment, a policy server has a processor operating under control of predefined instructions which define operations, including: after receiving an access policy information request message, performing an authentication operation; when the authentication operation is successful, accessing an access policy storage to obtain access policy information corresponding to a source of the access policy information request message; and outputting the corresponding access policy information in response to the access policy information request message. In this exemplary embodiment, the access policy information request message has a source address; and the corresponding access policy information output by the policy server includes an IPv6 address for use, at the source, as a new source address.

Additional aspects and advantages of the exemplary embodiments will be set forth in the detailed description below, will be obvious from the detailed description, or may be learned by practicing the exemplary embodiments.

The above and other features and advantages will become more apparent by reading the below description of exemplary embodiments, with reference to the attached drawings which are now briefly described.

### BRIEF DESCRIPTION OF THE DRAWINGS

FIG. 1 is a diagram showing the constitution of a system for managing an Internet protocol version 6 (IPv6) address and an access policy according to an exemplary embodiment.

FIG. 2 is a block diagram showing the constitution of a policy server for managing an IPv6 address and an access policy, according to an exemplary embodiment.

FIG. 3 is a table showing examples of network access policies set by a network administrator.

FIG. 4 is a flowchart illustrating a method of managing an IPv6 address and an access policy, according to an exemplary embodiment.

FIG. 5 shows an example of a setting of an IPv6 address of a terminal based on user access policy information.

### DETAILED DESCRIPTION OF EXEMPLARY EMBODIMENTS

Hereinafter, exemplary embodiments will be described in detail. The exemplary embodiments may, however, be embodied in many different forms and should not be construed as limited to just the exemplary embodiments set forth herein. Rather, the exemplary embodiments are provided so that this disclosure will be thorough and complete, and fully convey the scope of the inventive concept to those of ordinary skill in the art.

The terms used herein are for the purpose of describing particular exemplary embodiments only and are not intended to be limiting. As used herein, the singular forms “a”, “an” and “the” are intended to include the plural forms as well, unless the context clearly indicates otherwise. It will be further understood that the terms “comprises” and/or “comprising,” when used in this specification, do not preclude the presence or addition of one or more other components.

The matters defined in the description, such as detailed construction and elements, are provided to assist in a comprehensive understanding of the exemplary embodiments. However, it is apparent that the exemplary embodiments can be carried out by those of ordinary skill in the art without those specifically defined matters. In the description of the exemplary embodiment, certain detailed explanations of related art are omitted when it is deemed that they may unnecessarily obscure the essence of the inventive concept.

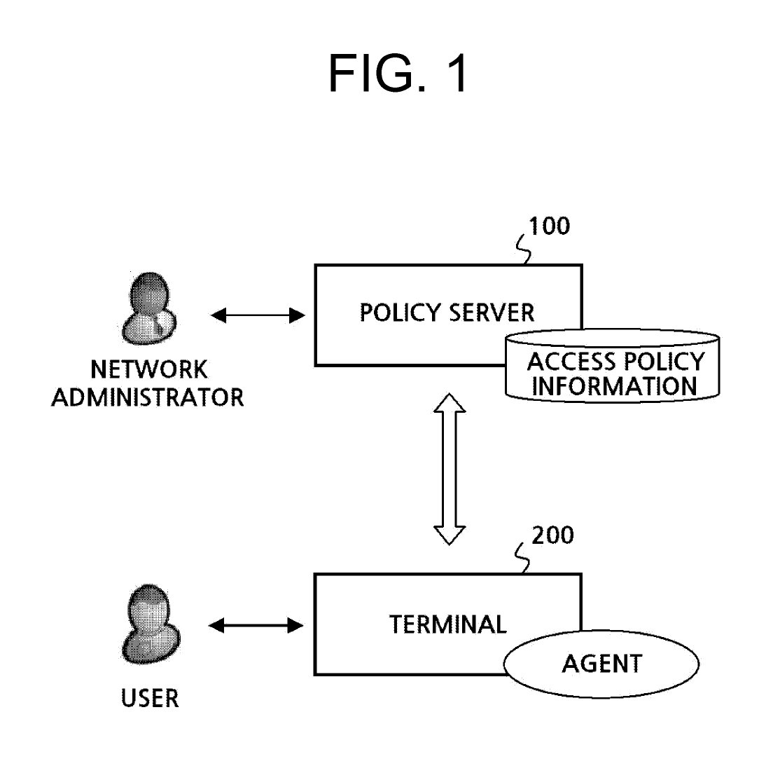

FIG. 1 is a diagram showing a constitution of a system for managing an Internet protocol version 6 (IPv6) address and an access policy according to an exemplary embodiment. In FIG. 1, the policy server and the terminal may both be implemented as computing devices which include a processor, memory, storage, input/output capability, and so on. In such computing devices, a processor carries out operations indicated by predefined instructions stored in a non-volatile memory.

In FIG. 1 there is shown a system for managing an IPv6 address and an access policy according to an exemplary embodiment includes a policy server 100 controlled by a network administrator, and at least one terminal 200 used for network access by an individual user. In the policy server 100, access policy information, which is set on a per-user or user group basis, is stored, and an agent module is included in the terminal 200 to receive access policy information from the policy server 100 and set an IPv6 address and an access policy function.

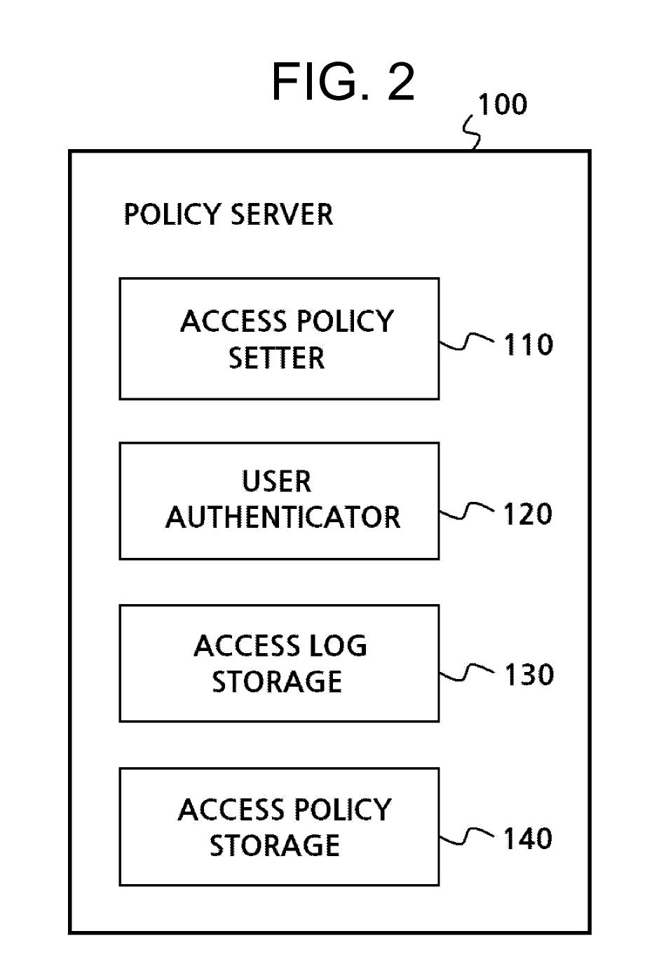

In this regard, FIG. 2 shows a more detailed constitution of the policy server 100 according to an exemplary embodiment. As shown in the drawing, the policy server 100 according to an exemplary embodiment includes, e.g., an access policy setter 110, a user authenticator 120, an access log storage 130, an access policy storage 140, and so on. The foregoing elements may operate under control of a controller or a control function (not shown).

The access policy setter 110 functions to set IPv6 addresses and to set network access policies to be assigned on a per-user or user group basis. In other words, the network administrator sets (inputs) IPv6 addresses and network access policies, on a per-user or user group basis, through the access policy setter 110, thereby remotely managing an IPv6 address and an access policy for the user terminal 200.

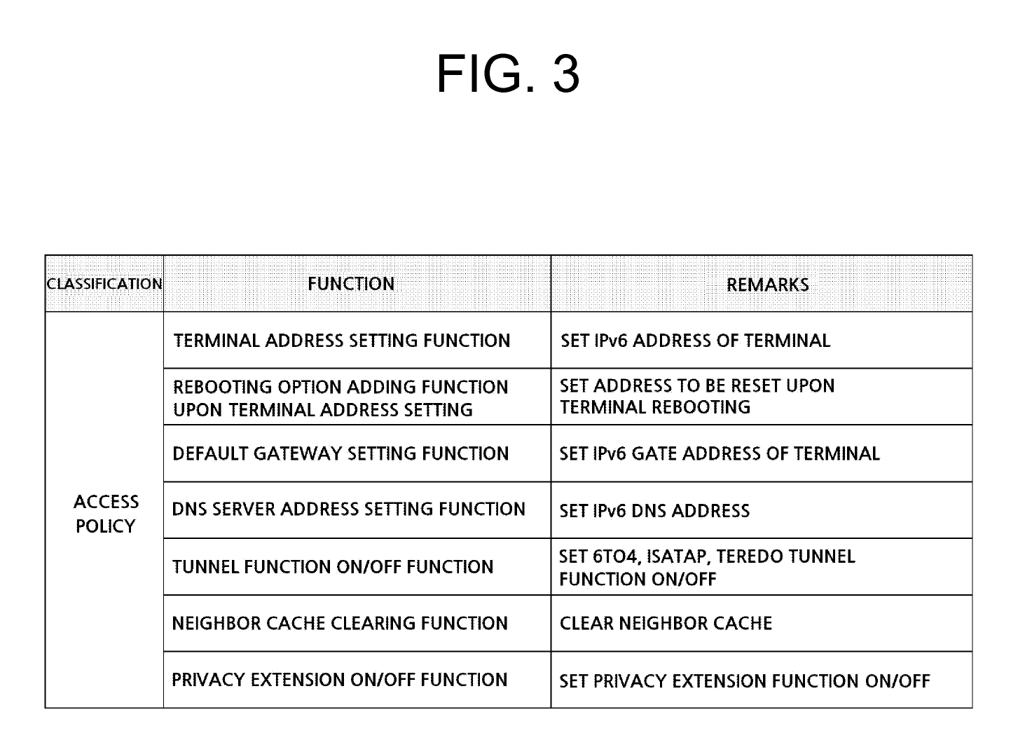

Examples of network access policies managed on a per-user or user group basis include, as shown in FIG. 3, a terminal address setting function (static IP address or dynamic IP address assignment), a rebooting option adding function upon terminal address setting, a default gateway setting function, a domain name service (DNS) server address setting function, a tunnel function on/off function, a neighbor cache clearing function, a privacy extension on/off function, and so on. The access policy setter 110 matches detailed access policies set by the network administrator, as mentioned above, to users, thereby generating access policy information.

When the user terminal 200 requests user access policy information from the policy server 100 (i.e., when the user terminal 200 sends an access policy information request message to the policy server 100), the user authenticator 120 requests user information on the terminal 200 and authenticates a user (i.e., the policy server 100 sends an authentication challenge message to the user terminal 200, and receives, in return, an authentication reply message from the user terminal 200). User authentication may be performed using a user identification (ID), a password, personal data of the user, a media access control (MAC) address of the user terminal 200, etc., and may also be performed using biometric information such as a fingerprint when a higher security level is required (i.e., the content of the authentication response message received at the policy server 200 may vary, depending on an employed authentication method). Another way to put this is to say that, in response to receiving an access policy information request message, the server authenticates the request.

When the user terminal 200 accesses the policy server 100, the access log storage 130 stores a user access record, such as the user terminal's IP address, MAC address, user name, access time, and access place of the terminal 200, in the form of a log entry.

The access policy storage 140 stores the user-specific access policy information, previously set by the network administrator through the access policy setter 110, in the form of a database.

Thus far, the system for managing an IPv6 address and for implementing an access policy according to an exemplary embodiment has been described. More detailed operations, functions, etc. of the respective components will be described, below, in the context of a method of managing IPv6 addresses and an access policy, according to an exemplary embodiment.

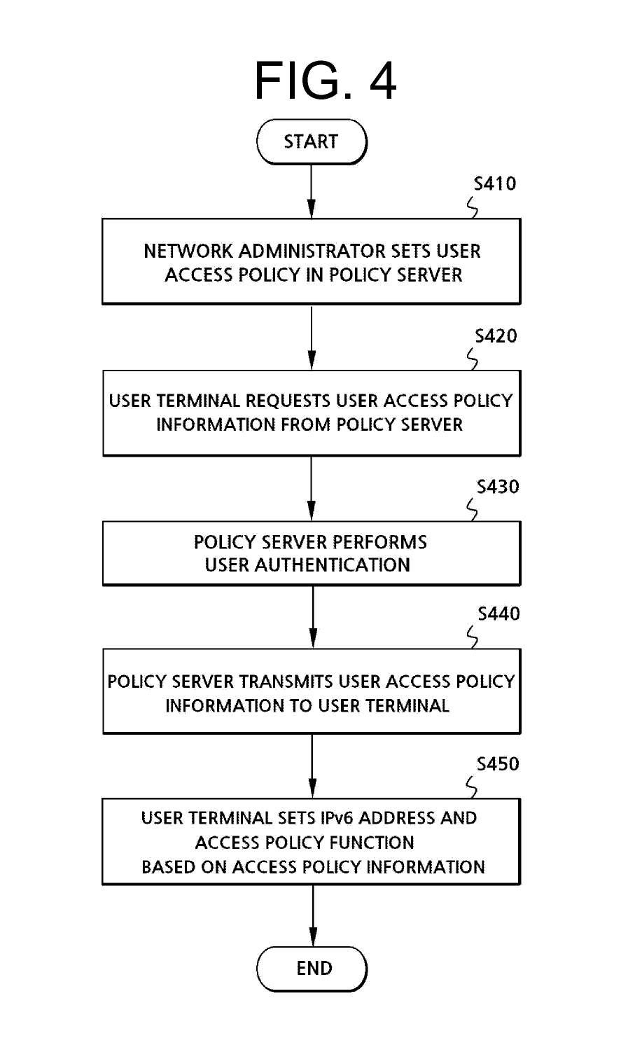

FIG. 4 is a flowchart illustrating a method of managing an IPv6 address and an access policy according to an exemplary embodiment.

Referring to FIG. 4, in step 410, a network administrator performs network policy information setting, such as i) the setting of subnet addresses according to respective workplaces within a company (i.e., setting of IPv6 address prefixes), ii) the setting of user-specific security levels according to whether or not respective users are staff members, departments, ranks, etc., iii) the setting of IPv6 addresses (static IP addresses or dynamic IP addresses) of user terminals, default gateways, DNS server addresses, tunnel function on/off, neighbor cache clearing, privacy extension on/off, etc., through the access policy setter 110 of the policy server 100.

In step 420, the user terminal 200 (specifically, an agent module) accesses the policy server 100 and requests user access policy information (e.g., by making an access policy information request), and in step 430, the user authenticator 120 of the policy server 100 requests user information from the user terminal 200 and performs authentication of a user (e.g., by presenting an authentication challenge and receiving, in response, an authentication reply). In this case, communication between the policy server 100 and the user terminal 200 may be performed using IPv4. In other words, the policy server 100 and the user terminal 200 according to an exemplary embodiment support an IPv4 and IPv6 dual stack, and may utilize an IPv4 or IPv6 link local address for communication between the policy server 100 and the user terminal 200 according to circumstances.

When the user authenticator 120 of the policy server 100 finishes the user authentication (e.g., in response to a successful authentication reply), in step 440, the user terminal 200 (specifically, the agent module) may request user access policy information from the policy server 100. Since the policy server 100 received a successful authentication reply, the policy server 100 may transmit, to the user terminal 200, the access policy information that corresponds or pertains to the user authenticated in step 430.

Then, in step 450, in response to receiving the access policy information in, e.g., an access policy information message, the user terminal 200 (specifically, the agent module) sets an IPv6 address and an access policy function of the terminal on the basis of the access policy information received from the policy server 100.

In addition, if the IPv4/IPv6 dual stack environment is employed, the user terminal 200 (specifically, the agent module) is first assigned an IPv4 address, accesses the policy server 100 to perform user authentication and to receive the user access policy information, and sets an IPv6 address and an access policy function of the terminal 200 on the basis of the thus obtained user access policy information. It will be appreciated that the agent module operates under control of a controller or a control function.

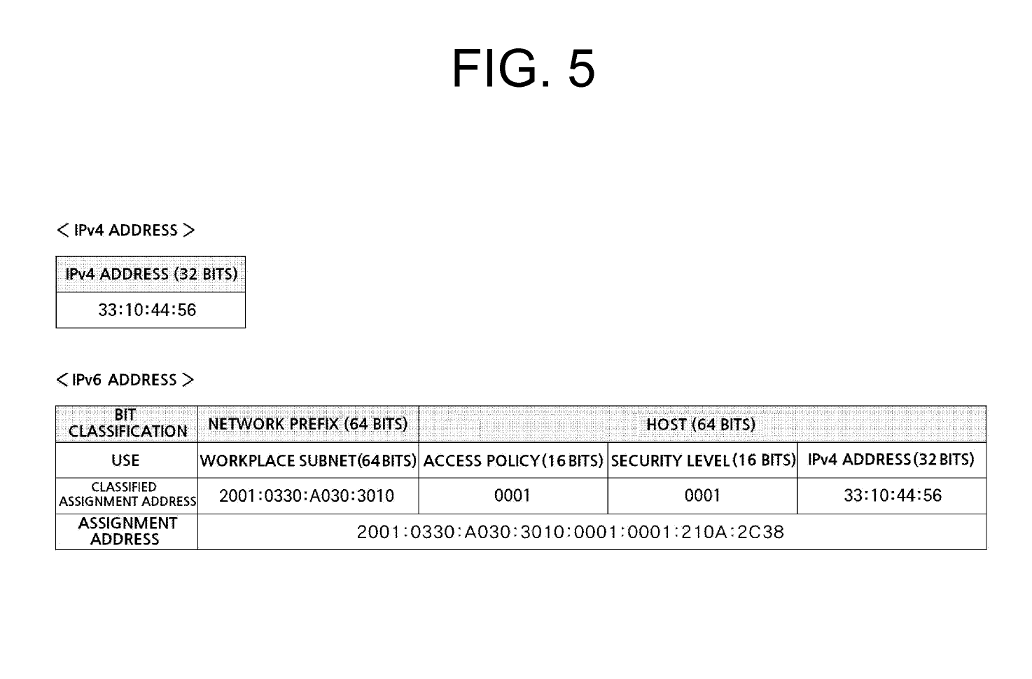

For reference, FIG. 5 shows an example of setting an IPv6 address of a terminal based on user access policy information, according to an exemplary embodiment where a dual stack environment is employed. Specifically, FIG. 5 shows an example of setting an IPv6 address by starting out with a conventionally-assigned IPv4 address (32 bits). Referring to FIG. 5, it is possible to set a 128-bit IPv6 address using, for example, a workplace subnet address (64 bits) as a prefix of the IPv6 address, and the conventionally assigned IPv4 address (32 bits), detailed access policies (16 bits) such as tunnel function on/off, and privacy extension on/off, and a security level (16 bits) relating to whether or not a user is a staff member, a department, a rank, etc. as a host of the IPv6 address.

Needless to say, the aforementioned FIG. 5 is only one example. In this example, the IPv4 address (which may be thought of as a first protocol address) has a value that is incorporated, bitwise, as part of the IPv6 address (which may be thought of as a second protocol address). Another way to put this is to say that the second protocol address is based on the first protocol address. Alternatively, the IPv6 address of the terminal 200 may be generated without being based on the IPv4 address, and without regard to the conventionally-assigned IPv4 address. Moreover, a prefix and/or a host portion of the IPv6 address may be configured differently than shown in FIG. 5.

Meanwhile, as described above, the user terminal 200, by requesting access policy information, and by sending a successful authentication reply, causes its agent module to receive user access policy information from the policy server 100, and to set an IPv6 address and an access policy function of the terminal 200, on the basis of the received access policy information, in an exemplary embodiment, such that the user terminal 200 can automatically set a complex IPv6 address, and such that a network administrator can remotely manage the user-specific IPv6 addresses and network access policies by way of effecting appropriate communication between the policy server 100 and the user terminal 200.

To summarize, according to an aspect of one or more exemplary embodiments, assignment of user-specific Internet protocol version 6 (IPv6) addresses is enabled, which is substantially impossible in the related art IPv6 automatic address assignment scheme. This allows a network administrator to remotely control and manage access policies. In other words, exemplary embodiments solve the problem of it being substantially impossible to know which site a specific user accesses when a terminal based on Windows or the like automatically generates an IPv6 terminal and performs prohibited communications with an external user, or when the terminal utilizes a temporary address based on RFC 4941. Thanks to this aspect of one or more exemplary embodiments, corporate security management can be strengthened.

According to an aspect of one or more exemplary embodiments, when user-specific IPv6 addresses need to be assigned, to comply with corporate policies, for example, an agent module installed in a terminal assigns a specific IPv6 address without requiring the user to manually set the address. This is different from a related art approach in which a user manually sets an IPv6 address, and so the user-specific IPv6 addresses can be readily assigned.

According to an aspect of one or more exemplary embodiments, a network administrator can control user-specific access policies through a policy server, and thereby can efficiently manage all user terminals together.

According to an aspect of one or more exemplary embodiments, IPv4 can be used for basic communication between a policy server and a terminal, thus efficiently operating in an environment in which IPv4 and IPv6 coexist as well as an environment in which only IPv6 is used.

While exemplary embodiments have been particularly shown and described, it will be understood by those of ordinary skill in the art that various changes in form and details may be made therein without departing from the spirit and scope of the invention as defined by the appended claims.

1. A system for managing an Internet protocol version 6 (IPv6) address and an access policy, comprising:
a policy server configured to manage network access policy information set on a per-user or user group basis; and
a user terminal having an agent module configured to access the policy server, authenticate a user, receive access policy information corresponding to the user, and automatically set an IPv6 address and an access policy function of the terminal on the basis of the access policy information.

2. The system of claim 1, wherein the IPv6 address of the user terminal is comprised of a 64-bit prefix portion corresponding to a subnet address of a workplace and a 64-bit host portion corresponding to a previously assigned IPv4 address and to the user access policy.

3. The system of claim 2, wherein the 64-bit host portion includes a security level of the user.

4. The system of claim 1, wherein the access policy information includes information on at least one of:
a terminal address setting function,
a rebooting option adding function upon terminal address setting,
a default gateway setting function,
a domain name service (DNS) server address setting function,
a tunnel function on or off function,
a neighbor cache clearing function, and
a privacy extension on or off function.

5. The system of claim 1, wherein the policy server and the user terminal:
both support an IPv4 and IPv6 dual stack, and
communicate for user authentication using IPv4 and IPv6 link local addresses.

6. A policy server for managing an Internet protocol version 6 (IPv6) address and an access policy, comprising:
an access policy setter configured to:
set IPv6 addresses and network access policies to be assigned on a per-user or user group basis and
generate user-specific access policy information;
a user authenticator configured to, when a user terminal accesses the policy server, request user information from the user terminal and carry out an authentication operation; and
an access policy storage configured to store the user-specific access policy information generated by the access policy setter.

7. The policy server of claim 6, wherein, when access policy information is requested by the user terminal, the policy server transmits to the user terminal access policy information corresponding to the user authenticated by the user authenticator.

8. The policy server of claim 6, wherein the access policy information includes information on at least one of
a terminal address setting function,
a rebooting option adding function upon terminal address setting,
a default gateway setting function,
a domain name service (DNS) server address setting function,
a tunnel function on or off function,
a neighbor cache clearing function, and
a privacy extension on or off function.

9. The policy server of claim 6, wherein the policy server supports an IPv4 and IPv6 dual stack, and utilizes IPv4 and IPv6 link local addresses to communicate with the user terminal for user authentication.

10. The policy server of claim 6, wherein the IPv6 addresses include a 64-bit prefix portion corresponding to a subnet address of a workplace and a 64-bit host portion including a previously assigned IPv4 address, the user access policies and a security level.

11. The policy server of claim 6, further comprising an access log storage configured to store an IP address, a media access control (MAC) address, a username and an access time of the user terminal, when the user terminal accesses the policy server.

12. A method of managing an Internet protocol version 6 (IPv6) address and an access policy, comprising:
a) setting, at a policy server, IPv6 addresses and network access policies on a per-user or user group basis, and generating user-specific access policy information;
b) accessing, at a user terminal, the policy server, responding to an authentication challenge, and receiving access policy information corresponding to the user; and
c) automatically setting, at the user terminal, an IPv6 address and an access policy function of the terminal, on the basis of the access policy information.

13. The method of claim 12, wherein, in step b), the user terminal receives the access policy information using an IPv4 address.

14. The method of claim 12, wherein the access policy information includes information on at least one of:
a terminal address setting function,
a rebooting option adding function upon terminal address setting,
a default gateway setting function,
a domain name service (DNS) server address setting function,
a tunnel function on or off function,
a neighbor cache clearing function, and
a privacy extension on or off function.

15. The method of claim 12, wherein the IPv6 address of the terminal includes a 64-bit prefix portion corresponding to a subnet address of a workplace and a 64-bit host portion corresponding to a previously assigned IPv4 address, the user access policy and a security level.

16. A policy server, comprising:
a processor operating under control of predefined instructions which define operations, including:
after receiving an access policy information request message, performing an authentication operation;
when the authentication operation is successful, accessing an access policy storage to obtain access policy information corresponding to a source of the access policy information request message; and
outputting the corresponding access policy information in response to the access policy information request message;
wherein:
the access policy information request message has a source address; and
the corresponding access policy information output by the policy server includes an IPv6 address for use, at the source, as a new source address.

17. The policy server as set forth in claim 16, wherein the source address is an IPv4 address.

18. The policy server as set forth in claim 17, wherein the IPv6 address for use as the new source address is based on the IPv4 address.

19. The policy server as set forth in claim 16, wherein the access policy information also includes information on at least one of:
a terminal address setting function,
a rebooting option adding function upon terminal address setting,
a default gateway setting function,
a domain name service (DNS) server address setting function,
a tunnel function on or off function,
a neighbor cache clearing function, and
a privacy extension on or off function.
